(19) United States
(12) Patent Application Publication
(10) Pub. No.: US 2026/0270223 A1
(43) Pub. Date: Sep. 10, 2026

(54) NON-TRANSITORY COMPUTER READABLE MEDIUM FOR CHATBOT PROGRAM AND CHATBOT APPARATUS

(71) Applicant: Honda Motor Co., Ltd., Tokyo (JP)

(72) Inventors: Tameaki Honda, Tokyo (JP); Hiroshi Honda, Tokyo (JP); Kazuki Yoshigai, Tokyo (JP)

(21) Appl. No.: 19/557,107

(22) Filed: Mar. 4, 2026

(30) Foreign Application Priority Data
Mar. 10, 2025 (JP) 2025-037056

(51) Int. Cl. H04L 51/02; G06F 16/3329

(52) U.S. Cl. CPC H04L 51/02; G06F 16/33295

(57) ABSTRACT

A chatbot program causes a computer to perform: receiving a chatbot session start request issued in response to an operation of a user from a user terminal, and starting a chatbot session; inputting question information input by the user through operation of the user terminal; classifying the question information into one of a plurality of question categories; executing a question-answer process in which source information for generating answer information corresponding to the classified question information is collected and the answer information generated based on the source information is transmitted to the user terminal; and when new question information is input, and as a result of being classified into one of the plurality of question categories, is classified into a question category different from the question category into which the question information input prior to the new question information has been classified, starting another question-answer process.

### CROSS-REFERENCE TO RELATED APPLICATION

This application is based upon and claims the benefit of priority from Japanese Patent Application No. 2025-037056 filed on Mar. 10, 2025, the content of which is incorporated herein by reference.

### BACKGROUND

### Technical Field

The present disclosure relates to a non-transitory computer readable medium for a chatbot program and a chatbot apparatus.

### Related Art

There is known a technology in which a server acquires a search query input by a user via a user terminal connected to the server and transmits answer information corresponding to the search query from the server to the user terminal. JP 2018-195076 A discloses a technology in which a server acquires a search query input by a user via a user terminal, specifies selected content that is content selected by the user among content searched based on the acquired search query, and determines a category of the search query based on a category set to the specified selected content.

The server and the user terminal are connected, and a session for a question and an answer is initiated between the server and the user terminal. A process is performed in which the server performs search processing corresponding to the query input from the user terminal in the started session, generates answer information based on the obtained search result, and transmits the answer information to the user terminal. During this process, when the server performs search processing, the server accesses a predetermined server, outputs a search command, or outputs a prompt to AI such as a large-scale language model (LLM) to obtain a result. Based on the result, answer information is generated and transmitted to the user terminal.

The above-described process is repeatedly performed in a session opened once, and a process is performed in consideration of the background (history, context) of the question and the answer in the session.

Therefore, in a case where the user inputs a query of a kind different from the query that has been input so far in one session, a response affected by the flow of the process so far is output, and thus, the response content does not necessarily match what the user desires. Therefore, in order to obtain a more accurate response, it has been necessary to close the session once, start a new session, and issue a new kind of query.

### SUMMARY

An aspect of the present invention is a computer-readable storage medium storing a chatbot program for execution by a computer comprising a processor and a memory, wherein the chatbot program causes the computer to perform: receiving a chatbot session start request issued in response to an operation of a user from a user terminal operated by the user, and starting a chatbot session; inputting, via the user terminal, question information input by the user through operation of the user terminal; analyzing the question information and classifying the question information into one of a plurality of question categories; executing a question-answer process in which source information for generating answer information corresponding to the question information classified into one of the categories is collected and the answer information generated based on the source information is transmitted to and presented on the user terminal; and when new question information is input via the user terminal during the chatbot session started, and as a result of being classified into one of the plurality of question categories, is classified into a question category different from the question category into which the question information input prior to the new question information has been classified, starting and executing another question-answer process independent of the question-answer process already ongoing.

Another aspect of the present invention is a chatbot device including: a microprocessor; and a memory connected to the microprocessor. The microprocessor is configured to perform: receiving a chatbot session start request issued in response to an operation of a user from a user terminal operated by the user, and start a chatbot session; inputting, via the user terminal, question information input by the user through operation of the user terminal; analyzing the question information and classifying the question information into one of a plurality of question categories; executing a question-answer process in which source information for generating answer information corresponding to the question information classified into one of the categories is collected and the answer information generated based on the source information is transmitted to and presented on the user terminal; and when new question information is input via the user terminal during the chatbot session started, and as a result of being classified into one of the plurality of question categories, is classified into a question category different from the question category into which the question information input prior to the new question information has been classified, starting and executing another question-answer process independent of the question-answer process already ongoing.

### BRIEF DESCRIPTION OF THE DRAWINGS

The objects, features, and advantages of the present invention will become clearer from the following description of embodiments in relation to the attached drawings, in which:

FIG. 1 is a conceptual diagram for explaining a general configuration of a chatbot system;

FIG. 2 is a diagram illustrating an example of content displayed on a display unit of a user terminal when a chatbot session is being held between a server and the user terminal;

FIG. 3 is a block diagram illustrating functional blocks of a server and components connected to the server via a network; and

FIG. 4 is a flowchart illustrating general processing steps of a chatbot response process executed by a CPU of the server that provides chatbot services to users.

### DETAILED DESCRIPTION

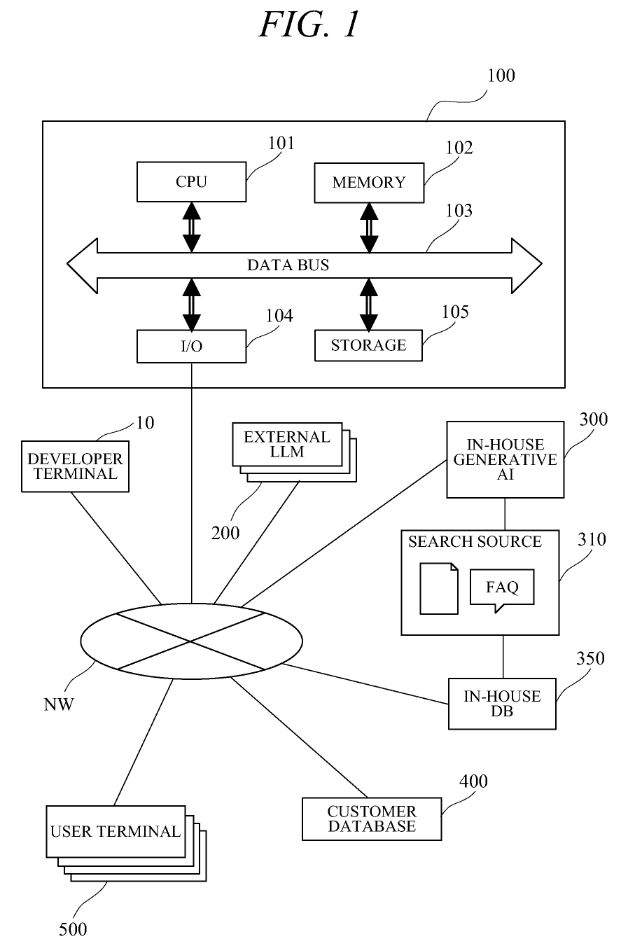

Hereinafter, an embodiment of the present disclosure will be described with reference to FIGS. 1 to 4. In all the drawings described below, common components are denoted by the same reference numerals, and repeated description is omitted. Note that not all the components shown in the following embodiments are essential components of the present disclosure.

FIG. 1 is a conceptual diagram for explaining a state in which a server 100 constituting a chatbot system is connected to a developer terminal 10, an external LLM 200, an in-house generative AI system (in-house generative AI) 300, an in-house database (in-house DB) 350, a customer database 400, and a user terminal 500 via a network NW. In FIG. 1, an example in which a common search source 310 is connected to the in-house generative AI system 300 and the in-house database 350 is illustrated, but independent search sources 310 may be connected individually. The search source 310 may be connected to the in-house generative AI system 300 or the in-house database 350 via the network NW. In addition, each of the in-house generative AI system 300 and the in-house database 350 may be configured to be able to access Web information and SNS information via the network NW.

In the present embodiment, the chatbot system can be assumed to be a system that responds to questions from the user, for example, regarding automobiles manufactured and sold by a company and services related to the automobiles.

The server 100 includes a CPU 101, a memory 102, an I/O 104, a storage 105, and a data bus 103 that enables data exchange between these elements.

A chatbot program for providing a chatbot service to the user is stored in, for example, the storage 105. The chatbot program may be read from the storage 105 when the server 100 is started, loaded into the memory 102, and executed by the CPU 101. Alternatively, the memory 102 may include a ROM, a flash memory, or the like, and a chatbot program stored in the ROM or the flash memory may be loaded into the memory 102 and executed by the CPU 101. In addition, a program obtained by being read from an optical disk drive device or a card reader (not illustrated) or being downloaded via the network NW may be loaded into the memory 102 and executed by the CPU 101.

Note that the server 100 can be virtually realized by providing all or a part of each hardware configuration in a distributed manner in a plurality of computers and connecting them to each other via the network NW or the like. That is, the server 100 is a concept including not only a server housed in a single housing or case but also a virtualized computer system.

The developer terminal 10 is operated by a system developer, a system administrator, or the like of a chatbot system of a company, an organization, or the like that provides the chatbot service of the present embodiment. Hereinafter, the description will be given on the assumption that the developer terminal 10 is operated by a system developer. The system developer performs maintenance of the server 100, the chatbot program, and the like as necessary. The system developer can also directly handle the server 100 without the developer terminal 10.

The external LLM 200 is, for example, an LLM provided by a third party. The LLM (Large Language Model) is a large scale artificial intelligence model constructed by using a large set of text data and deep learning technologies, and used in the field of natural language processing (NLP). The LLM can learn a large amount of text data (web pages, books, articles, and the like) to understand patterns of languages used by humans and effectively perform natural language generation (NLG) tasks.

Hereinafter, the use of the LLM as an external source when providing a chatbot service to a user will be described as an example, but another external service utilizing AI, such as ChatGPT, Google Gemini (registered trademark), Cerence (registered trademark), or Claude3 (registered trademark), may be used.

The in-house generative AI system 300 is a system which accumulates and constructs information of a company, which provides a chatbot service, as the search source 310, abundantly includes documents such as products and services sold and provided by the company and an operation manual accompanying the same, and information regarding a frequently asked question (FAQ) in the past, and can increase accuracy of an answer generated by AI and reduce hallucination. Furthermore, not only outputting a general answer to a question sent from the user who is driving the vehicle, but also it is possible to make a more specific response such as “Please press the switch with a green design on the lower left among the plurality of steering switches provided on the right steering spoke”. In addition, since the system is a company’s system, it is advantageous in that an increase in cost can be suppressed even in a case where a transaction at the time of interaction with AI increases during execution of a chatbot session.

The in-house database 350 searches the search source 310 for necessary information in response to the search command output from the server 100, and outputs the result to the server 100. Although FIG. 1 illustrates an example in which the in-house generative AI system 300 and the in-house database 350 access the common search source 310, as described above, independent search sources may be provided.

The customer database 400 is a database in which user data such as login information including a password are accumulated in association with a user ID when the user logs in to the chatbot service.

The user terminal 500 is an information processing device operated by a user who uses a chatbot service provided by the server 100. As the user terminal 500, for example, a smartphone, a tablet terminal, a personal digital assistant (PDA), a personal computer, or the like can be used, and in-vehicle infotainment (IVI) or another in-vehicle communication module can also be used. Furthermore, it is also possible that a manned chat operator is responsible for answering with the user, and the chat operator who has received a question from the chat user operates the user terminal 500 when obtaining necessary information for an answer.

The network NW for transmitting information between the elements described above can use the Internet. Note that the in-house generative AI system 300, the in-house database 350, the customer database 400, and the server 100 may be connected via a closed network service not via the Internet, or may be connected using a VPN technology. Alternatively, the in-house generative AI system 300 and the customer database 400 may be included in the server 100. It is desirable to protect the customer database 400 using a strong encryption technology in order to enhance information security.

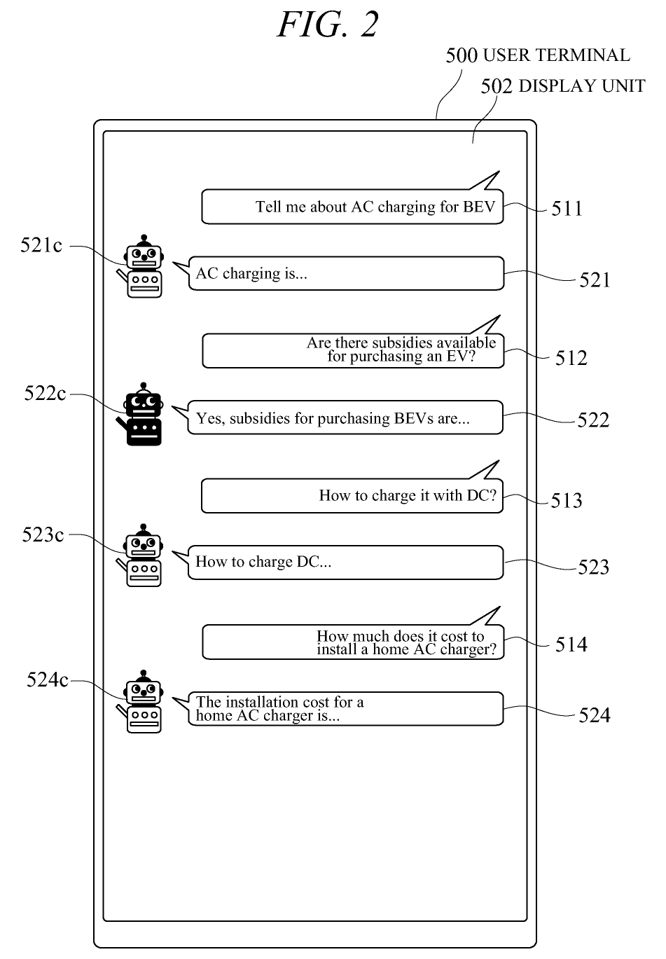

FIG. 2 illustrates a display example of the display unit 502 of the user terminal 500 after the user operates the user terminal 500 to log in to the chatbot service and start a chatbot session. A question input by a user (hereinafter, referred to as a chat user) who operates the user terminal 500 and an answer transmitted from the server 100 in response to the question are sequentially displayed on the display unit 502.

A display example when a chatbot session is being performed will be described with reference to FIG. 2. The question and the answer are displayed in a form in which character information is displayed in a balloon, and an image or another document can be displayed as necessary. Balloons are displayed from the top to the bottom of the display unit 502 in chronological order, and the screen is scrolled up when the balloons cannot be displayed on the screen. As a result, a balloon corresponding to the latest question and answer is always displayed on the lower side of the display unit 502.

In the balloon 511, a question regarding alternating current (AC) charging of a battery electric vehicle (BEV) input by the chat user by operating the user terminal 500 is displayed. The balloon 512 displays the answer related to the AC charging of the BEV transmitted from the server 100. At this time, a white-based icon (character) is displayed in the vicinity of the balloon 512, for example, on the left side of the balloon 512, and the chat user can intuitively recognize that the content displayed on the right side of the character 521c is the answer transmitted from the server 100.

In the balloon 512, a question from the chat user as to whether it is possible to receive the benefit of the grant from the national or local government when purchasing the BEV is displayed. This question is a question of a different kind from the question and answer about the AC charging of the BEV that have been performed so far. The server 100 analyzes and classifies a question (query) transmitted from the user terminal 500 operated by the chat user. Hereinafter, the query transmitted from the user terminal 500 operated by the chat user may be referred to as a “query transmitted from the chat user”.

As will be described in detail later, in the server 100, category classification information to be referred to in analyzing and classifying the query transmitted from the chat user is accumulated. The server 100 refers to the category classification information and classifies the query transmitted from the chat user into the most suitable category in the category classification information. The server 100 (CPU 101) is programmed to be able to generate a new category in the category classification information if the query sent by the chat user does not belong to any of the category classification information. In this case, the CPU 101 may be programmed to notify the developer terminal 10 that the new category classification item has been added to the category information. This will also be described in detail later.

The description returns to the description of the query displayed in the balloon 512. The question about the grant at the time of purchasing the BEV is a question of a different kind from the question (balloon 511) about the AC charging of the BEV. Conventionally, in one chatbot session, in a case where a question of a kind different from the flow of the interaction (question and answer) performed so far is newly made from the chat user, an answer to the new question is likely to be affected by the flow of the interaction performed so far. As a result, the answer output from the server 100 may deviate from what the chat user desires. For example, when the server should give an answer as to whether he/she can receive a grant from the national or local government when he/she newly purchases a BEV, under the influence of the flow of dialogue so far, an answer such as “The grant in a case where a household AC charging facility is installed in a house is...” has been given, and there has been a case where information necessary for the chat user cannot be necessarily obtained.

In contrast to the conventional example described above, in the present example, every time a query is transmitted from a chat user, the received query is classified into the most suitable category in the category classification information accumulated in advance. Then, when detecting that a question of a new category different from that of the question/answer process performed so far is input from the chat user, the CPU 101 is programmed to launch a question/answer process of a new kind in addition to the existing question/answer process. The CPU 101 performs a series of processes for answering a question from the chat user in the newly started question/answer process.

As a result of performing the processing as described above, the CPU 101 can give an answer displayed in the balloon 522 to the question from the chat user as to whether the grant is given when purchasing the BEV displayed in the balloon 512. In the balloon 522, an answer regarding the grant at the time of purchasing the BEV is displayed. At this time, the character 522c displayed on the left side of the balloon 522 is different from the character 521c and is based on black, so that the chat user can intuitively recognize that a question/answer process of a new kind has started up and an answer has been made.

As a form of presenting the fact that the question/answer process of a new kind has started to the chat user, the shape and form of the character may be changed in addition to changing the basic color of the character. Alternatively, the color of the frame of the balloon for displaying the answer information, the background color, the drawing pattern, or the like of the area for displaying the answer information in the balloon may be changed, or the background color or the pattern of the balloon may be changed. The color of the characters displayed in the speech balloon may be changed. Furthermore, before presenting the answer information, a question input from the chat user may be repeated as “Let us answer about....” or the like. In a case where the answer information is presented to the chat user by voice, it is possible to change the tone of voice, change the chime sound uttered before the answer, or repeat the question as described above.

In the balloon 513, a question newly input from the chat user is displayed. As an example, it is assumed that a question regarding direct current (DC) charging of the BEV is input from the chat user. Then, it is assumed that the CPU 101 analyzes and classifies the question input from the chat user and determines that the question conforms to the original question/answer process. In this case, an answer that is displayed in the balloon 523 is made in response to the question in the balloon 513. Then, the character 523c displayed on the left side of the balloon 523 is switched to the same character as the character 521c displayed in the initial question/answer process.

In the balloon 514, a question regarding the installation cost of the home AC charger used for charging the BEV is displayed as the next question input from the chat user. It is assumed that the CPU 101 analyzes and classifies the question and determines that the question conforms to the original question/answer process. In this case, an answer that is displayed in the balloon 524 is made in response to the question in the balloon 514. Then, as the character 524c displayed on the left side of the balloon 524, similar to the character 523c, the same character as the character 521c displayed in the initial question/answer process is displayed.

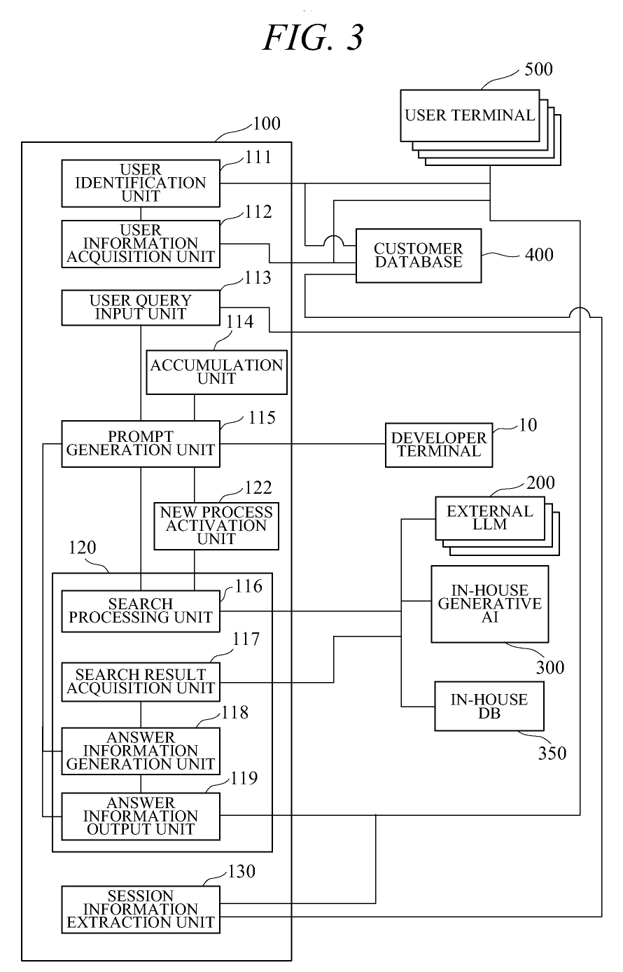

FIG. 3 is a block diagram for explaining a chatbot processing unit realized by the CPU 101 of the server 100 executing a chatbot program. FIG. 3 also illustrates external elements connected to the server 100 via the network NW.

A user identification unit 111 exchanges a user ID and a password with the user terminal 500 that is connected to the server 100 and intends to start a chatbot session, and identifies and authenticates the user based on the user ID and the login information acquired by accessing the customer database 400. A user information acquisition unit 112 acquires the user data corresponding to the user identified by the user identification unit 111 from the customer database 400. The user data includes information that can identify question information regarding a question output from a chat user in a chatbot session performed in the past, answer information output for the question information, and the like.

A user query input unit 113 inputs a query input from the chat user. Specifically, the user query input unit 113 receives a query input by the chat user via the user terminal 500 from the user terminal 500. The user query input unit 113 outputs the query received from the user terminal 500 to a query analysis/classification processing unit query processing unit (hereinafter, simply referred to as a query processing unit) 115. The query input from the chat user may be text-based or by voice input.

The query processing unit 115 analyzes a query (received from the user terminal 500) input from the chat user, extracts a question word, and classifies the query. Classification information to be referred to when the query processing unit 115 classifies the query is accumulated in the classification information accumulation unit (hereinafter, simply referred to as an accumulation unit) 114.

In a case where the query input from the chat user does not belong to any classification accumulated in the classification information accumulation unit 114, the query processing unit 115 generates new classification information and additionally registers the generated classification information in the classification information accumulation unit 114. At that time, a notification indicating that the new classification information has been additionally registered in the classification information accumulation unit 114 is issued to the developer terminal 10. This notification can be received by a system developer or a system administrator who operates the developer terminal 10.

In a case where the chatbot session is started and a query is output from the user, the above-described query analysis/classification processing is performed on the query, and labeling is performed based on the classification result of the query. That is, the query and the information indicating the classification result of the query are associated with each other. Hereinafter, the information indicating the classification result of the query may be referred to as query labeling information.

Based on the above-described query classification result performed by the query processing unit 115, the question/answer processing unit 120 executes a question/answer process described below.

The question/answer processing unit 120 includes a search processing unit 116, a search result acquisition unit 117, an answer information generation unit 118, and an answer information output unit 119. The search processing unit 116 generates a prompt to be output to the external LLM 200 or the in-house generative AI 300 or a search command to be output to the in-house database 350 based on the query labeling information, and outputs the prompt and the search command to any one or a plurality of the external LLM 200, the in-house generative AI system 300, and the in-house database 350.

The search result acquisition unit 117 acquires an answer output from any one or a plurality of the external LLM 200, the in-house generative AI system 300, and the in-house database 350 described above. The answer information generation unit 118 generates answer information to be output to the chat user based on the answer acquired by the search result acquisition unit 117. The answer information output unit 119 outputs the answer information generated by the answer information generation unit 118 to the user terminal 500 operated by the chat user.

When the chatbot session is opened and a query is output from the chat user, the above-described question/answer process is executed in the question/answer processing unit 120 (search processing unit 116, search result acquisition unit 117, answer information generation unit 118, and answer information output unit 119).

Here, a case where another query is output from the chat user in the same chatbot session will be described. When another query is input from the chat user by the user query input unit 113, the query processing unit 115 analyzes the query as described above, extracts question words, and classifies the query. In a case where the query labeling information obtained as a result of the classification is the same as the query labeling information of the previous question/answer process, the above-described question/answer process is repeatedly executed.

On the other hand, in a case where the labeling information obtained as a result of classifying the query newly output from the chat user is different from the query labeling information of the previous question/answer process, the query processing unit 115 outputs the query labeling information corresponding to the new query to the new question/answer process activation unit (hereinafter, simply referred to as a new process activation unit) 122.

The new process activation unit 122 outputs, to the question/answer processing unit 120, a command to additionally execute a question/answer process independent of the question/answer process performed so far based on the query labeling information corresponding to the new query. In response to this command, the question/answer processing unit 120 additionally performs a question/answer process of a different kind from that which has been performed so far.

Specifically, a prompt or a search command is generated based on new query labeling information, and search processing independent of a question/answer process that has been performed so far is performed. As a result, for example, as described with reference to FIG. 2, the answer information is displayed in the balloon 522 together with the character 522c on the display unit 502 of the user terminal 500. As a result, it is possible to eliminate the influence of the previous question/answer process and to provide more accurate answer information to the chat user.

Thereafter, another query may be output from the chat user, and the query labeling information corresponding to the query may match the query labeling information of any of the question/answer processes that have been performed before the other query has been output from the chat user. In that case, the question/answer processing unit 120 may perform search processing as a continuation of the question/answer process in which the query labeling information matches, and output answer information generated based on the obtained search result to the chat user.

When one chatbot session ends, a session information extraction unit 130 extracts information that can specify a query and an answer exchanged with the user terminal 500 within the chatbot session, and information that can specify when the chatbot session starts and ends, and adds the extracted information to the customer database 400. Alternatively, the above information can be added to the customer database 400 every time the question/answer process is performed once after the chatbot session is started.

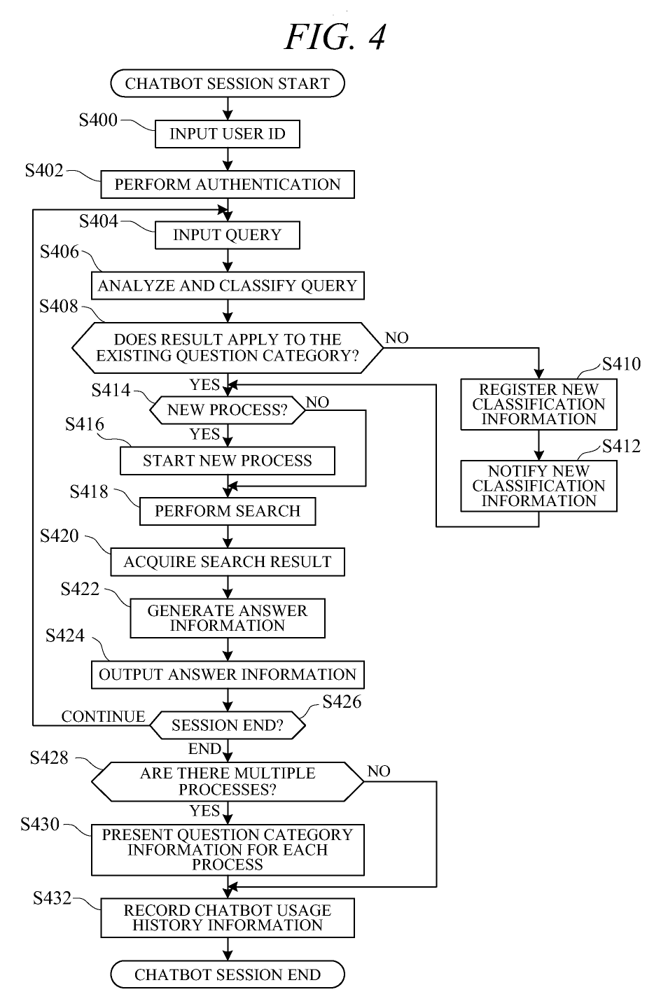

FIG. 4 is a flowchart for explaining a flow of chatbot response processing executed by the CPU 101 of the server 100. When the chat user operates the user terminal 500 to start the chatbot session, the CPU 101 acquires the user ID from the user terminal 500 in S400.

In S402, the CPU 101 accesses the customer database 400 to acquire the login information corresponding to the login ID of the chat user. Then, authentication processing is performed by collating the password information included in the login information with the password input from the chat user.

In S404, the CPU 101 inputs the query uttered by the chat user. Specifically, the CPU 101 receives, from the user terminal 500, a query input by the chat user via the user terminal 500. In S406, the CPU 101 analyzes the content of the query from the chat user input (received from the user terminal 500) in S404, extracts a question word, and classifies the query. For example, the query is analyzed based on content desired by the chat user, such as “I want to know”, “I want to go”, “I want to do”, “I want to buy”, “I want to eat”, “I want to watch”, and “I want to listen”, combinations of words and parts of speech in the query, appearance order of words and parts of speech, context, and the like. The CPU 101 refers to the classification information accumulated in the classification information accumulation unit 114 to determine a question category having a high degree of coincidence with the analysis result.

In S408, the CPU 101 determines whether the result of the query analysis/classification performed in S406 applies to any question category accumulated in the classification information accumulation unit 114, and when it is determined that the result does not apply to any question category, that is, when it is determined that the result does not apply to the existing question category, classification information of a new question category is generated in S410 and is additionally registered in the classification information accumulation unit 114. Then, the newly registered classification (question category) is associated (labeled) with the query. In S412, the CPU 101 issues a notification indicating that the new classification information has been additionally registered in the classification information accumulation unit 114 to the developer terminal 10, and the process proceeds to S414.

When the result of the query analysis/classification performed in S406 applies to any question category accumulated in the classification information accumulation unit 114, the question category is labeled in the query.

Then, the determination in S408 is affirmative, and the process proceeds to S414.

In S414, the CPU 101 determines whether a new question/answer process is to be activated. Specifically, the CPU 101 determines whether the result of the classification of the query performed in S406 is the same as the result of the classification of the query input before the query. When the determination in S414 is affirmative, that is, the question category of the newly input query is different from the question category in the question/answer process that has been performed so far, and it is determined that a new question/answer process is to be activated, the process proceeds to S416, and a new question/answer process is activated. When the determination in S414 is negative, the process proceeds to S418.

The above will be described in more specific examples. A new query is input in S404 via the user terminal 500 during the chatbot session. As a result of the query being classified into any of the plurality of question categories in S406, in a case where it is determined in S414 that the query is classified into a new question category different from the classified question category into which the query input before the new query is classified, another (new) question/answer process independent of the already performed question/answer process is activated and executed in S416.

Here, the new question/answer process means that, when the server 100 outputs a prompt to the external LLM 200 or the in-house generative AI system 300 or outputs a search command to the in-house database 350 based on the query input from the chat user (in this specification, this is simply referred to as “search”), search is performed in a new kind independent of search performed in the question/answer process that has already been performed. As a result, answer information for a new query can be obtained without being affected by the question/answer process that has already been performed.

In the example described with reference to FIG. 2, the query displayed in the balloon 511 and the answer displayed in the balloon 521 correspond to the question/answer process that has already been performed. Furthermore, the query displayed in the balloon 512 and the answer displayed in the balloon 522 correspond to another question/answer process independent of the question/answer process that has already been performed.

In S418, the CPU 101 performs search processing. At this time, a search according to the question/answer process that has been performed so far or a search in a new kind is performed according to the determination result in S414. In S420, the CPU 101 acquires a search result from the search destination (any one or more of the external LLM 200, the in-house generative AI system 300, and the in-house database 350).

The CPU 101 performs processing of generating answer information in S422 based on the search result acquired in S420 and transmitting the answer information to the user terminal 500 operated by the chat user in S424. In S426, the CPU 101 determines whether the operation for ending the chatbot session is performed in the user terminal 500 operated by the chat user, and when the determination is negative, the process returns to S404 to receive a query input from the chat user. On the other hand, when the determination in S426 is affirmative, the process proceeds to S428, and it is determined whether a plurality of question/answer processes have been performed in the chatbot session opened so far.

When the determination in S428 is affirmative, in S430, the CPU 101 sends information related to each of the plurality of question categories corresponding to the plurality of question/answer processes performed in the session opened so far to the user terminal 500. As a result, information regarding each of the plurality of question categories is presented to the user terminal 500. By the user recognizing the information regarding each of the plurality of question categories presented to the user terminal 500, the user using the chatbot can know that the intention of the question uttered by the user using the chatbot is firmly understood, and a sense of security to the user can be brought.

Following the process in S430, or in a case where the determination in S428 is negative, the process proceeds to S432. In S432, the CPU 101 records the use history information of the chatbot by the chat user in the customer database 400, and ends the chatbot session.

The process of S428 can also be performed between S424 and S426. By doing so, it is possible to update the information of the chatbot use history every time one question/answer process is completed.

An example in which the server 100 providing the chatbot service and the chat user operating the user terminal 500 directly exchange with each other has been described above, but an operator may intervene. For example, the operator accepts questions from the user in the form of voice or text. The operator can access the server 100 by using the user terminal 500 to open a chatbot session and obtain an answer indicated to the user. At this time, the operator may correspond to a plurality of users in the same time period. In that case, for example, when different kinds of questions are received from the user A and the user B, a plurality of searches are not affected by each other even if the operation of switching the chatbot session performed with the server 100 is not performed, and thus, it is possible to present an accurate search result to each user.

According to the present embodiment, the following operations and effects are achievable.

(1) The chatbot program is for causing a computer 100 (FIG. 1) including the processor 101 and the memory 102 to execute receiving, from the user terminal 500 operated by a user, a chatbot session start request issued in association with an operation of the user, and starting a chatbot session, inputting, via the user terminal 500, question information input by the user operating the user terminal 500 (FIG. 4, S404), analyzing the question information and classifying the question information into any one of a plurality of question categories (S406), performing a question/answer process (S418, S420, S422, S424) of collecting original information for generating answer information corresponding to the question information classified into any one of the categories (S418) and transmitting the answer information generated based on the original information to the user terminal 500 to present the answer information (S424), and in a case where new question information is input via the user terminal 500 during the started chatbot session (S404), and as a result of being classified into any of a plurality of question categories (S406), the question information input before the new question information is classified into a question category different from the classified question category (S414: Yes), activating and executing another question/answer process independent of the already performed question/answer process (S416).

According to this, even if the user utters a query different from the kind (topic) of the question information (query) that the user has uttered so far in one chatbot session, it is possible to present more accurate answer information to the user without being affected by the search that has been performed so far.

(2) In the chatbot program, in a case where processing of classifying the information into a plurality of question categories is executed during the started chatbot session (S414: Yes S428: Yes in FIG. 4), the computer 100 is caused to execute presenting information regarding each of the classified question categories to the user at the end of the chatbot session (S430).

According to the above, since it is possible to notify the user that the intention of the question by the user is firmly understood, it is possible to provide the user with a sense of security.

(3) In the chatbot program, the computer 100 is caused to execute additionally registering new classification information in the category classification information (S410) in a case where the category classification information that is information to be referred to when the question information is classified into any of the plurality of question categories is stored in advance in the storage unit (classification information accumulation unit 114 in FIG. 3), and the question information is analyzed (S406 in FIG. 4) and as a result, the question information does not belong to any of the plurality of question categories (S408: No).

According to this, it is possible to accumulate new classification information while the chatbot session is operated every day.

(4) In the chatbot program, the computer 100 is further caused to execute notifying a management server, which manages the chatbot program, that the new classification information has been additionally registered in the category classification information (S412).

According to this, by notifying the management server that the new classification information has been additionally registered in the category classification information, the system developer or the system administrator of the chat system can recognize that the new classification information has been additionally registered in the category classification information, and the maintainability of the chatbot system is improved.

(5) In the chatbot program, in a case where new question information is input via the user terminal 500 during the started chatbot session, and as a result of being classified into any one of the plurality of question categories, the question information input before the new question information is classified into a question category different from the classified question category, a form when the answer information is transmitted to the user terminal 500 and presented is different from a presentation form of the answer information in the question/answer process that has already been performed.

According to this, since the answer information is presented in a form according to the kind of the question information, the user who has received the answer information can suppress confusion even if the answer information for the queries of the plurality of kinds is mixed.

(6) A chatbot device 100 (FIG. 3) includes a session start processing unit 111, 112 that receives a chatbot session start request issued according to an operation of a user from a user terminal 500 operated by the user and starts a chatbot session, the user query input unit 113 serving as a question information input unit that inputs question information input by the user operating the user terminal 500 via the user terminal 500, a query processing unit 115 that analyzes the question information and classifies the question information into any one of a plurality of question categories, a question/answer processing unit 120 (116, 117, 118, 119) that executes a question/answer process of collecting original information corresponding to the question information classified into categories and generating answer information, and transmitting and presenting answer information generated based on the original information to the user terminal 500, and a new process activation unit 122 that starts and executes another question/answer process independent of a question/answer process that has already been performed in a case where new question information is input via the user terminal 500 during a started chatbot session, and as a result of being classified into any of a plurality of question categories, the question information input before the new question information is classified into a question category different from the classified question category.

According to this, even if the user utters a query different from the kind (topic) of the question information (query) that the user has uttered so far in one chatbot session, it is possible to present more accurate answer information to the user without being affected by the search that has been performed so far.

The above embodiment can be combined as desired with one or more of the aforesaid modifications. The modifications can also be combined with one another.

According to the present disclosure, even if the user utters a query different from the kind (topic) of the question information (query) that the user has uttered so far in one chatbot session, it is possible to present more accurate answer information to the user without being affected by the search that has been performed so far.

Above, while the present invention has been described with reference to the preferred embodiments thereof, it will be understood, by those skilled in the art, that various changes and modifications may be made thereto without departing from the scope of the appended claims.

What is claimed is:

1. A computer-readable storage medium storing a chatbot program for execution by a computer comprising a processor and a memory, wherein the chatbot program causes the computer to perform:
receiving a chatbot session start request issued in response to an operation of a user from a user terminal operated by the user, and starting a chatbot session;
inputting, via the user terminal, question information input by the user through operation of the user terminal;
analyzing the question information and classifying the question information into one of a plurality of question categories;
executing a question-answer process in which source information for generating answer information corresponding to the question information classified into one of the categories is collected and the answer information generated based on the source information is transmitted to and presented on the user terminal; and
when new question information is input via the user terminal during the chatbot session started, and as a result of being classified into one of the plurality of question categories, is classified into a question category different from the question category into which the question information input prior to the new question information has been classified, starting and executing another question-answer process independent of the question-answer process already ongoing.

2. The storage medium according to claim 1, wherein
the chatbot program causes the computer to perform:
when a process of classifying into the plurality of question categories is executed during the chatbot session started, presenting, to the user at the end of the chatbot session, information regarding each of the question categories classified.

3. The storage medium according to claim 1, wherein
the chatbot program causes the computer to perform:
category classification information, the classification information being information referred to when classifying into one of the plurality of question categories, is stored in the memory in advance; and
as a result of analyzing the question information, if the question information does not belong to any of the plurality of question categories, additionally registering new classification information in the category classification information.

4. The storage medium according to claim 3, wherein
the chatbot program causes the computer to further perform:
notifying a management server managing the chatbot program that the new classification information has been additionally registered in the category classification information.

5. The storage medium according to claim 1, wherein
the chatbot program causes the computer to perform:
when new question information is input via the user terminal during the chatbot session started, and as a result of being classified into one of the plurality of question categories, is classified into a question category different from the question category into which the question information input prior to the new question information has been classified, making a form of transmitting and presenting the answer information to the user terminal different from a form of presenting answer information in the question-answer process already ongoing.

6. A chatbot device comprising:
a microprocessor; and
a memory connected to the microprocessor, wherein
the microprocessor is configured to perform:
receiving a chatbot session start request issued in response to an operation of a user from a user terminal operated by the user, and start a chatbot session;
inputting, via the user terminal, question information input by the user through operation of the user terminal;
analyzing the question information and classifying the question information into one of a plurality of question categories;
executing a question-answer process in which source information for generating answer information corresponding to the question information classified into one of the categories is collected and the answer information generated based on the source information is transmitted to and presented on the user terminal; and
when new question information is input via the user terminal during the chatbot session started, and as a result of being classified into one of the plurality of question categories, is classified into a question category different from the question category into which the question information input prior to the new question information has been classified, starting and executing another question-answer process independent of the question-answer process already ongoing.
